(19) United States
(12) Patent Application Publication
(10) Pub. No.: US 2024/0364536 A1
(43) Pub. Date: Oct. 31, 2024

(54) PROVISIONING A VOLATILE SECURITY CONTEXT IN A ROOT OF TRUST

(71) Applicant: CRYPTOGRAPHY RESEARCH, INC., San Jose, CA (US)

(72) Inventors: Joel Wittenauer, Pleasanton, CA (US); Matthew E. Orzen, San Francisco, CA (US)

(21) Appl. No.: 18/641,965

(22) Filed: Apr. 22, 2024

Related U.S. Application Data
(60) Provisional application No. 63/462,740, filed on Apr. 28, 2023.

(51) Int. Cl. H04L 9/32; H04L 9/08

(52) U.S. Cl. CPC H04L 9/3247; H04L 9/0825; H04L 9/0894

(57) ABSTRACT

A first device receives, from a second device, a request to provision a security context for the second device. The first device transmits a nonce value to the second device and receives, from the second device, a data structure encoding the security context and a cryptographically signed digest of a combination of the data structure, the nonce value, and a public key. The first device determines a first digest using the nonce value and cryptographically signed digest, and a second digest using the data structure, the nonce value, and the public key. Responsive to determining that the first digest matches the second digest, the first device provisions the security context for the second device by storing the security context on the volatile memory.

### RELATED APPLICATION

This application claims the benefit of U.S. Provisional Application No. 63/462,740, filed Apr. 28, 2023, the entire content of which is hereby incorporated by reference.

### TECHNICAL FIELD

Aspects and implementations of the disclosure relate to roots of trust, and more specifically, to systems and methods for using volatile memory to provision a security context in a root of trust.

### BACKGROUND

Some computing systems can apply a set of access control settings (referred to as “permissions”) for an application either before it executes or during the runtime of the application (e.g., a container, a pod, a virtual machine, a native application, an executable image, etc.). A security context defines these permissions for the application. These permissions can be used for the application, the user that requested the execution of the application, or any combination thereof. These permissions can be managed by software executing at a higher privilege, such as kernel access controls.

A secure root of trust is like a general-purpose computing system in that there are access controls in place. A root of trust often differs from a general-purpose computing system's access control, where the root of trust access control is managed by hardware state machines implemented in the peripherals (e.g., an auxiliary hardware device). For example, when an executable is loaded, the root of trust verifies the executable under some previously established security context known to the root of trust. This security context includes a set of permissions that are used for the application at the root of trust peripherals. For example, for an executable image, the peripherals can enforce the security context's permissions such that the image's executable code can access only allowed secure data assets (e.g., encrypted data, cryptographic keys, authenticated data, a signed certificate, etc.). In certain systems, a root of trust has the security context and permissions provisioned to its non-volatile memory (NVM) or one-time-programmable (OTP) memory prior to loading an image to execute under that security context. Provisioning can include the process of creating and/or setting up an information technology infrastructure, and includes the operations required to manage user and system access to various resources.

### BRIEF DESCRIPTION OF THE DRAWINGS

The present disclosure is illustrated by way of example, and not by way of limitation, in the figures of the accompanying drawings.

FIG. 1 illustrates a network diagram of a computer system, in accordance with some implementations of the disclosure.

FIG. 2 is a sequence diagram illustrating using volatile memory to provision a security context in a root of trust, in accordance with some implementations of the disclosure.

FIG. 3 schematically illustrates example metadata maintained by the computing device, in accordance with some implementations of the present disclosure.

FIG. 4 depicts a flow diagram of an example method of using volatile memory to provision a security context in a root of trust, in accordance with some implementations of the disclosure.

FIG. 5 depicts a flow diagram of an example method of requesting the provisioning of a volatile security context in a root of trust, in accordance with some implementations of the disclosure.

FIG. 6 is a block diagram illustrating an exemplary computer system, in accordance with some implementations of the disclosure.

### DETAILED DESCRIPTION

Technologies for using volatile memory to provision a security context in a hardware root of trust (RoT) are described. The following description sets forth numerous specific details, such as examples of specific systems, components, methods, and so forth, in order to provide a good understanding of several implementations of the present disclosure. It will be apparent to one skilled in the art, however, that at least some implementations of the present disclosure can be practiced without these specific details. In other instances, well-known components or methods are not described in detail or presented in simple block diagram format to avoid obscuring the present disclosure unnecessarily. Thus, the specific details set forth are merely exemplary. Implementations can vary from these exemplary details and still be contemplated to be within the scope of the present disclosure.

In general, a computing device can include a hardware ROT that utilizes a security context to perform its responsibilities and provide security guarantees. Data in the security context can include a device stage (e.g., lifecycle, characterization values, or the like), runtime or execution context, secure data assets (e.g., encrypted data, cryptographic keys, authenticated data, a signed certificate, etc.), and so forth. For operation of the hardware ROT, one or more security contexts can be provisioned to the computing device and stored in secure memory, such as one-time-programmable (OTP) memory. Each security context can be assigned a set of permissions (e.g., access to secure data assets). When an application (e.g., a container, a pod, a virtual machine, a native application, an executable image, etc.) is loaded on the computing device, the application can be executed under an assigned security context. In particular, when the application is loaded and/or is executed, the ROT can search its OTP (or other memory) to determine the permissions (e.g., access rights) assigned to the application. For example, the RoT can grant the application access to certain data assets allowed by the security context.

In the on-chip OTP memory approach, a hardware RoT typically relies upon some amount of on-chip OTP storage in order to maintain the security context(s). Reliance upon this resource typically imposes a limitation on the number of security contexts a computing device can store. Thus, the on-chip non-volatile memory approach can introduce some challenges, such as cost, size, and availability.

Aspects of the present disclosure and implementations address these problems and others by providing a hardware ROT architecture and methods to provision a security context in the RoT using volatile memory. In particular, a provisioning device can request a computing device to provision a security context for an application. The computing device can protect master keys and authorize the setup, installation, configuration and operation of components or applications of certain computing systems. The security context can be expressed as a data structure (e.g., a metadata table). For example, the data structure can include an identifier of the security context and access rights (e.g., permissions) to one or more secure assets. The computing device can generate a nonce and store the nonce in its volatile memory. The computing device can also send a copy of the nonce to provisioning device. The provisioning device can then generate a hash digest of the nonce, a public key associated with the application, and a concatenation of the security context data structure. The public key can be a part of a private-public key pair associated with the application. The provisioning device can then generate a cryptographic signature by signing the hash digest using the private key of the key pair. The provisioning device can send, to the computing device, the cryptographic signature along with the security context data structure and the public key. In some implementations, the public key can be a pre-shared key (PSK) that was previously provided to the computing device.

Responsive to receipt, the computing device can obtain the nonce from its volatile storage and generate a verification hash digest using the nonce along with the public key and the data structure received from the provisioning device. The computing device can then verify the cryptographic signature by decrypting the signed hash digest using the public key and determining whether the value of the decrypted hash digest matches the value of the verification hash digest. If verified, the computing device can store the security context (e.g., the data structure) on the volatile memory.

Once the security context is provisioned to the computing device (e.g., stored on the volatile memory), the application can be executed under the security context. In particular, when the application is loaded and/or is executed, the computing device can search the volatile memory to determine whether the application's security context matches a stored security context. Responsive to detecting the security context stored on the volatile memory, the related permissions are used to control access of the application to various resources. For example, the computing device can grant access, to the application, to cryptographic keys allowed by the security context, install a data asset on the computing device, etc.

As noted, a technical problem addressed by implementations of the disclosure is the use of limited non-volatile memory available on the RoT of a computing device. In certain systems, this non-volatile memory is one-time-programmable (OTP) memory. This allows the computing device to provision only a relatively small number of security contexts (e.g., 1, 2, 4, or 8).

A technical solution to the above identified technical problems can include configuring the computing device to use volatile memory to provision security contexts. Thus, the technical effect can include the computing device being able to provision a relatively large number of security contexts without consuming expensive and limited non-volatile memory. Furthermore, upon reset of the computing device, the security contexts are erased from the volatile memory. This adds a new layer of security, and allows for a new set of security context to be provisioned during the next operational period.

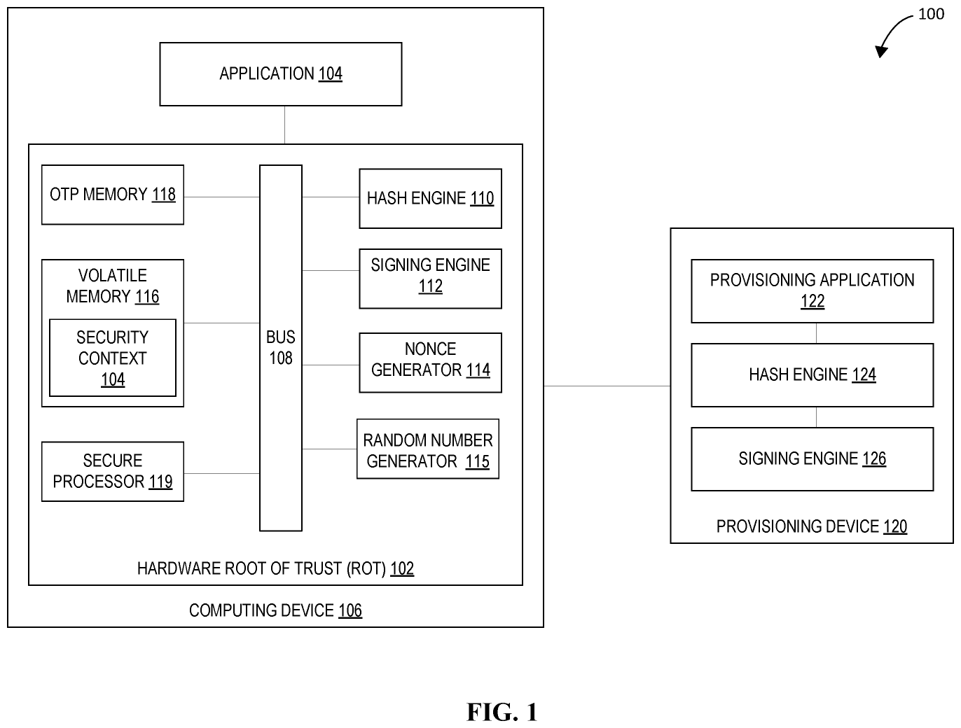

FIG. 1 is a block diagram of a computing system 100 with a hardware RoT 102 for provisioning a security context 104 in volatile memory 116, according to at least one implementation. The computing system 100 includes a computing device 106 with the hardware RoT 102 and provisioning device 120. Computing device 106 can include other circuitry, such as a central processing unit (CPU), or the like. For example, computing device 106 can include one or more integrated circuits in which the hardware RoT 102 can be implemented.

In some implementations, the computing system 100 can provide secure transaction processing and data reporting infrastructure designed to provide secure key and asset management capabilities to a computing device 106 (e.g., mobile devices, appliance, etc.) and/or other computing device, hosting systems, etc. configured to communicate with computing device 106. In some implementations, the user or customer for the computing system 100 can include fabless semiconductor vendors, for example, that produce chipsets for mobile devices, system integrators (OEMs) that manufacture internet connected devices, or mobile network operators (MNOs) that deploy these devices on their wireless networks, etc. Such customers can contract out some of the fabrication of their devices or components to third-party manufacturers that operating remote manufacturing facilities, such as a high-volume manufacturing site.

In the manufacturing of certain devices, software, codes, keys and other important sensitive assets (e.g., data assets) can be embedded in or installed on the hardware devices. The management of these data assets can be important to the security and revenues of the customer. The implementations described herein provide secure-asset management systems and technologies to securely provision data assets, to these hardware devices, using computing device 106.

Computing device 106 can include Hardware RoT 102 and application 104. Hardware RoT 102 includes cryptographic hash engine 110, signing engine 112, nonce generator 114, random number generator 115, volatile memory 116, one-time-programming (OTP) memory 118, and secure processor 119. The component of hardware RoT 102 can be connected via a bus 108 which may have its own logic circuits, e.g., a bus interface logic unit. Computing device 106 can further include additional components (not shown) outside of hardware RoT 102. For example, computing device 106 can include a primary processor (e.g., a central processing unit (CPU), or the like), an interface (IF) controller, a memory device, non-volatile memory (NVM) storage device, etc. Interface circuitry, such as the interface controller, can be configured to receive messages from an external system over a communications link. The primary processor can process requests from the external entity, from provisioning device 120, from application 104, etc. Secure processor 119 can perform cryptographic functions on behalf of the primary processor. In some implementations, the primary processor is responsible for overall control of the computing device 106, while the secure processor 119 operates on behalf of the primary processor. The memory device can refer to computer memory that requires power to maintain the stored information (e.g., random-access memory (RAM), dynamic random-access memory (DRAM), synchronous DRAM (SDRAM), static memory (e.g., static random-access memory (SRAM)) etc.) Non-volatile storage device can be any type of computer memory that can retain stored information even after power is removed, such as flash memory (e.g., NAND flash, solid-state drives (SSD), etc.), read-only memory (ROM), EPROM (erasable programmable ROM), EEPROM (electrically erasable programmable ROM), hard disk drives, optical drives, etc.

Application 104 can refer to software that runs on a high-level operating system (OS), such a Linux or other OS. Application 104 can perform one or more custom functions and/or procedures, and/or make calls over a communications link or bus to retrieve data and/or request services. In some implementations, computing device 106 can run the executable code of application 104. In other implementations, application 104 can be executed on an external system in communication with computing device 106. In some implementations, application 104 can be bound to a security context (e.g., security context 104) that is provisioned on volatile memory 116. The application can then be used to provision secure data assets to RoT 102. This will be explained in detail below.

Provisioning device 120 includes provisioning application 122, cryptographic hash engine 124, and signing engine 126. Computing device 106 and provisioning device 120 can communicate via a wireless (e.g., a wireless network) or wired connection. Provisioning application 122 can refer to software performs one or more functions or procedure related to provisioning a security context 106 on computing device 106 (e.g., on volatile memory 116).

The OTP memory 118 can be a type of digital memory implemented in circuitry or silicon of a device that can be programmed and cannot be changed after being programmed. For example, security context data and/or data assets can be programmed onto OTP memory 118 and the data cannot be changed in the OTP memory 118 after the programming. OTP memory 118 can be a type of digital memory where the setting of each bit of the OTP memory 118 is locked by a fuse (e.g., an electrical fuse associated with a low resistance and designed to be permanently break an electrically conductive path after the programming or setting of a corresponding bit) or an antifuse (e.g., an electrical component associated with an initial high resistance and designed to permanently create an electrically conductive path after the programming or setting of a corresponding bit). As an example, each bit of the OTP memory 118 can start with an initial value of ‘0’ and can be programmed or set to a later value of ‘1’ (or vice versa). Thus, in order to program or set a device specific key or a unique device identification (ID) with a value of ‘10001’ into OTP memory 118, two bits of OTP memory 118 can be programmed from the initial value of ‘0’ to the later value of ‘1.’ Once the two bits of OTP memory 118 have been programmed to the later value of ‘1’, then the two bits cannot be programmed back to the value of ‘0.’ As such, the bits of OTP memory 118 can be programmed once and cannot be changed once programmed.

As described above, the architecture of the hardware RoT 102 does not rely on the use of on-chip non-volatile storage (e.g., OTP memory 118) to provision a security context 104 for application 104, an external computing device, an external host system, etc. Rather, the hardware RoT 102 utilizes volatile memory 116 to provision a security context(s) 104 for application 104.

Security context 104 can refer to secure data that is often encrypted and can be used to generate a secure data asset. In some implementations, a security context 104 can include one or more cryptographic private keys, public keys, access states (e.g., permissions), and/or additional data. In some implementations, security context 104 is only data (e.g., no software code). A data asset (also referred to as a “secure data asset” or “secure asset” herein) can refer to sensitive data that is generated, at least in part, by a computing device 106. A data asset can include one or more of encrypted data (e.g., cryptographic keys), authenticated data (e.g., confirmation of the origin and/or integrity of the data), or a certificate (e.g., a data block authenticated using an authenticating digital signature). In some implementations, the data asset can include a sequence (e.g., a set of commands or script). In some implementations, the data asset can include specialized software code.

Volatile memory 116 can refer to computer memory that requires power to maintain the stored information. Volatile memory 116 can include random-access memory (RAM), dynamic random-access memory (DRAM), synchronous DRAM (SDRAM), static memory (e.g., static random-access memory (SRAM)) etc.

Nonce generator 114 can generate a nonce (e.g., a nonce value). The nonce value can be an arbitrary value used just once in a cryptographic communication or operation. In some implementations, the nonce value can be a concatenation of one or more of parameters, such as an initialization vector (IV), the memory address referencing a location of the user data, a counter value, a random number, etc. In some implementations, the nonce can be a random number obtained from a random number generator 115.

Random number generator 115 can be a hardware random number generator (HRNG) or true random number generator (TRNG) that generates random numbers from a physical process (rather than by means of an algorithm). In some implementations, random number generator 115 can generate random numbers based on microscopic phenomena that generate low-level, statistically random “noise” signals, such as thermal noise, the photoelectric effect, involving a beam splitter, and other quantum phenomena. In other implementations, random number generator 115 can refer to a software implemented application configured to generate random numbers.

Cryptographic hash engine 110, 124 can cryptographically hash values. In particular, cryptographic hash engine 110 can apply a hashing function, perform one or more cryptographic hashes, etc. over one or more values to generate a hash digest. In some implementations, cryptographic hash engine can apply the hashing function over one or more of a concatenation of a security context, a nonce, a public key, a private key, etc.

Signing engine 112, 126 can generate a cryptographic output (e.g., cryptographic signature) that can later be used to verify the integrity and authenticity of data. In particular, signing engine 112, 126 can sign data, such as a hash digest, using a cryptographic key (e.g., a private key, a pre-shared key, etc.). Signing engine 112, 126 can include a Message Authentication Codes (MAC) engine, or any other type of signing engine. Signing engine 112, 126 can perform a signing operation and a verification operation. The signing operation uses a cryptographic key to generate a cryptographic signature over raw data. The verification operation can validate signed data using the same or a different cryptographic key. For example, data can be signed using a private key of a public-private key pair and the signed data can be verified using the public key of the key pair.

Provisioning device 120 can be any computer or other device that communicates with computing device 106. Provisioning device 120 can include at least one memory device to store security context data and/or data assets. In some implementations, provisioning device 120 includes a monolithic integrated circuit. Provisioning device 120 can execute provisioning application 122.

Provisioning application 122 refers to software that runs on a high-level operating system (OS), such a Linux or other OS. The application 122 can perform one or more custom functions and/or procedures, and/or make calls over the network (e.g., unsecured public network) to retrieve data and/or request services.

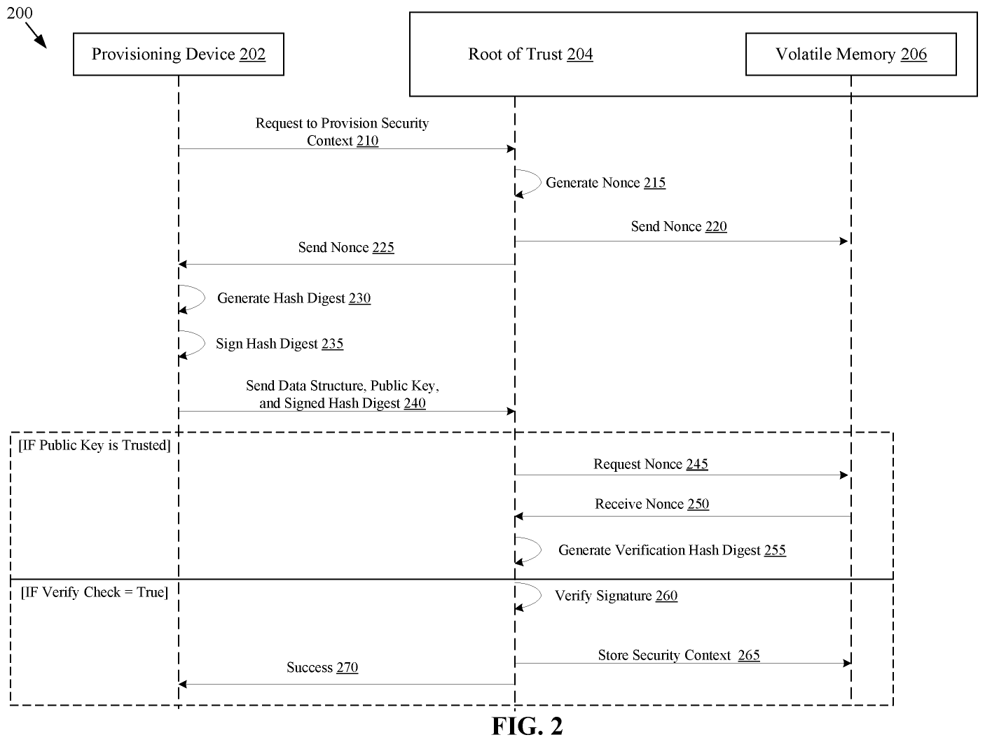

FIG. 2 is a sequence diagram illustrating using volatile memory to provision a security context in a root of trust, in accordance with some implementations of the disclosure. Diagram 200 can include similar elements as illustrated in computer system 100 as described with respect to FIG. 1. It can be noted that elements of FIG. 1 can be used herein to help describe FIG. 2. The operations described with respect to FIG. 2 are shown to be performed serially for the sake of illustration, rather than limitation. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed.

Diagram 200 illustrates provisioning device 202, Root of Trust (RoT) 204, and volatile memory 206. Provisioning device 202 can be similar or the same as provisioning device 120. For example, provisioning device 202 can include a manufacturing appliance, manufacturing infrastructure, a peripheral device, an integrated circuit, etc. RoT 204 can be similar or the same as RoT 102. In some implementations. RoT 204 can be part of a computing device (e.g., computing device 106). Volatile memory 206 can include any time of volatile memory (e.g., SRAM, RAM, etc.). In some implementations, volatile memory 206 can be part of RoT 204. In other implementations, volatile memory 206 can be part of the computing device and configured to communicate (e.g., via a databus) with RoT 204. In some implementations, provisioning device 202 can run a provisioning application that runs on a high-level OS, such as Linux or some other OS. In some implementations, the application can be executing on a processing device (e.g., unsecured or untrusted processing device) of provisioning device 202. In some implementations, provisioning device 202 can be directly connected to a network, such as a public or private network, and be able to communicate with RoT 202. In some implementations, provisioning device 202 and RoT 204 can communicate directly via, for example, a wired connection. In some implementations, operations performed by the root of trust can be performed by one or more of secure processor 119 and/or a primary processor of computing device 106.

At operation 210, provisioning device 202 requests to provision a security context. In some implementations, the provisioning device 202 can initiate the request via, for example, a software application. The security context can include a data structure (e.g., a metadata table) specifying one or more desired security contexts. In some implementations, the security context can include the identifier of the provisioning device (e.g., provisioning device 202) and one or more context permissions.

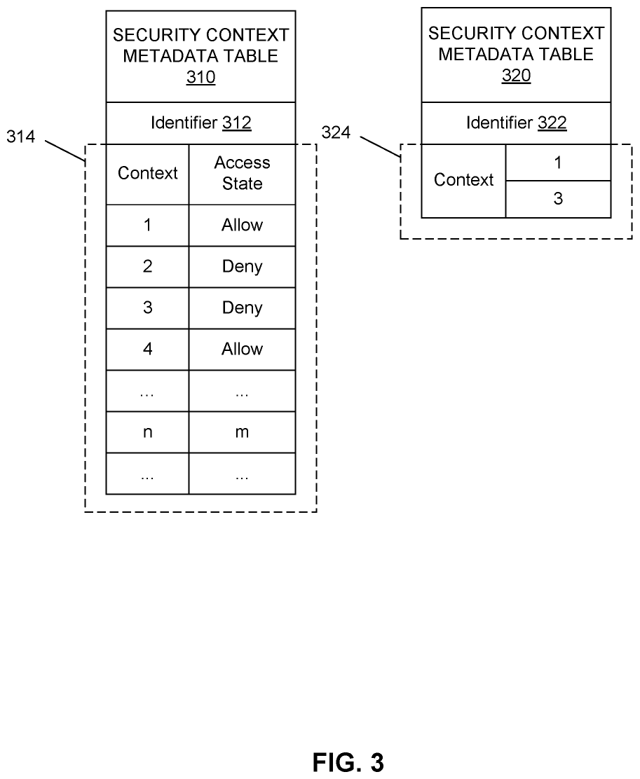

FIG. 3 schematically illustrates example metadata maintained by the provisioning device, in accordance with some implementations of the present disclosure. In particular, provisioning device 202 can maintain one or more security context metadata tables 310, 320. Security context metadata table 310, 320 can include an identifier 312, 322 and one or more access control policies 314, 324. The identifier can be related to one or a set of security contexts (e.g., a user case, an asset, etc.). In some implementations, the identifier can be a public key of a public-private key pair associated with a particular application executable by provisioning device 202. In some implementations, an identifier can be a number, a string, etc. The access control polices can be indicative of access rights (e.g., permissions) for applications that execute under the security context.

Security context metadata table 310, 320 can be stored in the local memory (e.g., non-volatile memory) of provisioning device 202. As illustrated by security context metadata table 310, each context (e.g., context 1, context 2, etc.) can be indicative of a specific resource or resource group and can correlate to a particular access state (e.g., allow, deny, etc.). For example, metadata table 310 indicates that access to use case 1 is allowed, access to use case 2 is denied, access to use case 3 is denied, access to use case 4 is allowed, etc. Metadata table 320 indicates that access to use context 1 and 3 is allowed.

Returning to FIG. 2, at operation 215, RoT 204 generates a nonce. In some implementations, RoT 204 can use a nonce generator (e.g., nonce generator 114) to generate the nonce. For example, nonce generator 114 can sample a random number generator to obtain random value, and generate a nonce based on the random value (e.g., apply a formula to the random value). In some implementations, the nonce can be the random value.

At operation 220, RoT 204 sends the nonce to volatile memory 206.

At operation 225, RoT 204 sends the nonce to provisioning device 202.

At operation 230, provisioning device 202 generate a hash digest. The hash digest can be the output of a hash function (e.g., hash (data)=hash digest). In some implementations, provisioning device 202 can generate the hash digest using the security context (e.g., a concatenation of the security context for which provisioning was requested), the nonce, and a public key (e.g., hash (secure_context|nonce|public_key)=hash digest). In some implementations, the public key can be pre-provisioned to RoT 204. The public key can be part of a private-public key pair. As will be explained in operation 235 below, the private key can be used to sign the has digest.

At operation 235, provisioning device 202 generates a digital signature. To generate the digital signature, the provisioning device can sign the hash digest using a private key. The private key can be part of the public-private key pair where the public key of the key pair was used to generate the hash digest at operation 230.

At operation 240, provisioning device 240 sends the digital signature, the public key, and the security context to RoT 204.

At operation 245, RoT 204 requests the nonce from volatile memory 206. For example, provisioning device 245 can request data, from volatile memory 206, stored at a particular memory address corresponding to the nonce.

At operation 250, volatile memory 206 sends the nonce to RoT 204.

At operation 255, RoT 204 generate a verification hash digest. The verification hash digest can be used to verify the hash digest received from provisioning device 202. In some implementations, RoT 204 can generate the verification hash digest using the nonce obtained from volatile memory 206, and the security context (e.g., a concatenation of the security context) and public key received from provisioning device 202 (e.g., hash (secure_context|nonce|public_key)=hash digest).

In some implementations, operations 245-255 can be performed in response to determining that the public key can be trusted. For example, ROT device can compare the public key received from provisioning device 202 (during operation 240) to a stored public key related to provisioning device 202. In response to determining that the received public key and the stored public key match (e.g., are the same), RoT 204 can perform operations 245-255. In response to determining that the received public key does not match the stored public key (e.g., the keys are not the same), RoT 204 can reject the request to provision a security context. In other implementations, other methods can be used to verify the public key.

At operation 260, RoT 204 verifies the signature (e.g., signed hash digest) received from provisioning device 202 (at operation 240). In some implementations, RoT 204 verifies the signature using the public key and the verification hash digest. For example, ROT 204 can decrypt the signature using the public key and compare the decrypted hash digest with the verification hash digest (e.g., compare the value of the decrypted hash digest with the verification hash digest). If the values match, the signature is verified. If the values fail to match, the signature is not verified.

Responsive to RoT 204 successfully verifying the signature, RoT 204 stores, at operation 265, the security context on volatile memory 206. In some implementations, RoT 204 can send an indication to provisioning device 202 (e.g., at operation 270) that the verification was successful and/or that the security context was provisioned. Computing device 106 or an external entity (via application 104) can now access the provisioned security context. For example, the RoT 204 can grant access, to application 104, to cryptographic keys allowed by the security context, install a data asset on the computing device 106, etc. In some implementations, computing device 106 can request RoT 104 to execute an application (e.g., application 104) that is bound to the volatile security context. Application 104 can then be used to provision secure assets to RoT 204.

Responsive to RoT 204 failing to verify the signature, RoT 204 can reject the request to provision a security context. In some implementations, RoT 204 can send an indication to provisioning device 202 that the verification was failed and/or that the security context was not generated.

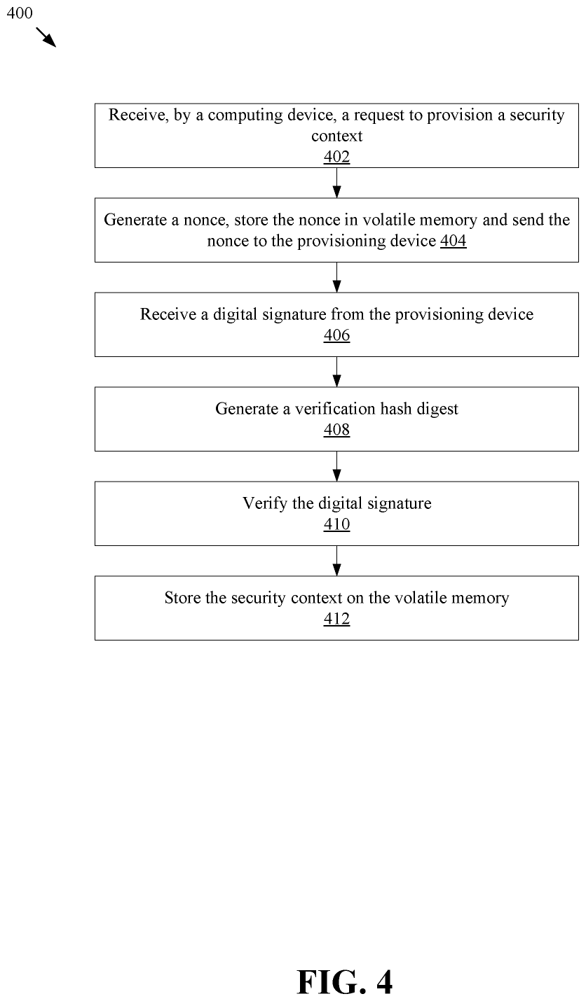

FIG. 4 depicts a flow diagram of an example method 400 of using volatile memory to provision a security context in a root of trust, in accordance with some implementations of the disclosure. The individual functions, routines, subroutines, or operations of method 400 can be performed by a processing device, having one or more processing units (CPU) and memory devices communicatively coupled to the CPU(s). In some implementations, method 400 can be performed by a single processing thread or alternatively by two or more processing threads, each thread executing one or more individual functions, routines, subroutines, or operations of the method. Method 400 as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 400 can be performed by computing device 106 (via RoT 102) and/or root of trust 204 as described in FIGS. 1 and 2. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed. It can be noted that elements of FIGS. 1 and 2 can be used herein to help describe FIG. 4.

At operation 402 of method 400, processing logic receives, from a provisioning device, a request to provision a security context.

At operation 404, processing logic generates a nonce value. The nonce value can be a random number generated using a random number generator, a concatenation of once or more values, etc. The processing logic can store the nonce on the volatile memory of the root of trust. The processing logic can also send a copy of the nonce to the provisioning device.

At operation 406, processing logic receives a digital signature from the provisioning device. The digital signature can be a cryptographically signed hash digest. The hash digest can be generated using a concatenation of the data structure encoding the security context, a nonce value, and a public key of a public-private key pair associated with an application (e.g., application 104). The hash digest can be signed using the private key of the key pair. In some implementations, the processing logic can also receive the public key and the data structure encoding the security context. In some embodiments, the processing logic can determine a first digest using the public key and the cryptographically signed hash digest (e.g., by applying the public key to the cryptographically signed hash digest to decrypt the cryptographically signed hash digest).

At operation 408, the processing logic generates a second (verification) digest. To generate the verification digest, the processing logic can obtain the nonce value from the volatile memory and hash the nonce value, the security context and the public key received from the provisioning device at operation 406.

At operation 410, processing logic verifies the digital signature. In one implementation, the processing logic can verify the digital signature using the first digest and the verification digest. For example, the processing logic can decrypt the cryptographically signed hash digest using the public key and compare the decrypted hash digest (first digest) with the verification digest. If the first digest and the verification digest match, the signature is verified. If the digests fail to match, the signature is not verified.

At operation 412, in response to successfully verifying the signature, processing logic stores the security context (the data structure encoding the security context) on the volatile memory. The processing logic can then send an indication to the provisioning device that the verification was successful and/or that the security context was provisioned.

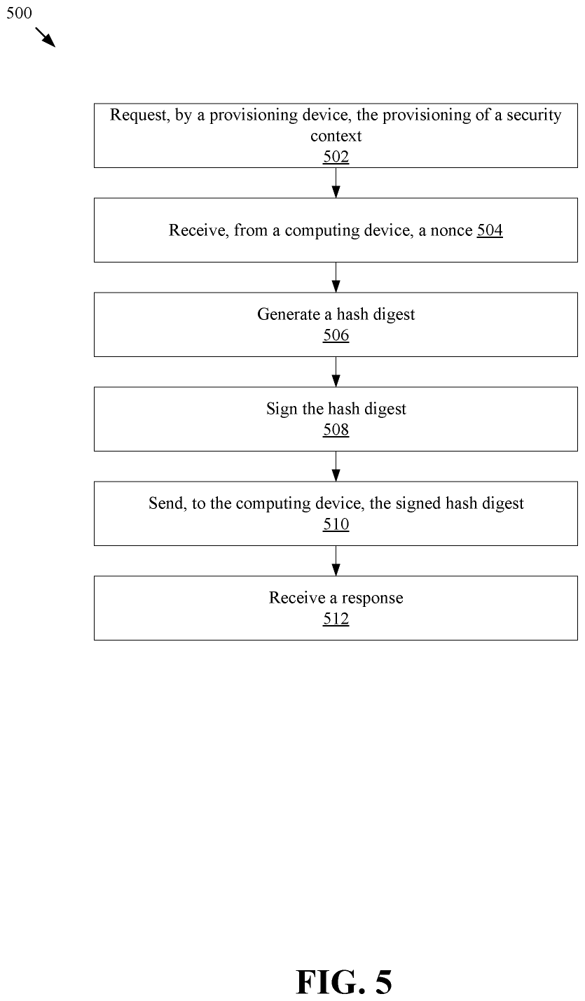

FIG. 5 depicts a flow diagram of an example method 500 of requesting the provisioning of a volatile security context in a root of trust, in accordance with some implementations of the disclosure. The individual functions, routines, subroutines, or operations of method 500 can be performed by a processing device, having one or more processing units (CPU) and memory devices communicatively coupled to the CPU(s). In some implementations, method 500 can be performed by a single processing thread or alternatively by two or more processing threads, each thread executing one or more individual functions, routines, subroutines, or operations of the method. Method 500 as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 500 can be performed by provisioning device 120 and/or provisioning device 202 as described in FIGS. 1 and 2. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed. It can be noted that elements of FIGS. 1 and 2 can be used herein to help describe FIG. 5.

At operation 502, processing logic sends a request, to a computing device, to provision a security context.

At operation 504, processing logic receives, from the computing device, a nonce value.

At operation 506, processing logic generates a hash digest. The hash digest can be the output of a hash function. In some implementations, the processing logic can generate the hash digest using a concatenation of the security context (e.g., a concatenation of the data structure related to the security context), the nonce, and a public key. The public key can be part of a private-public key pair.

At operation 508, processing logic signs the hash digest using, for example, the private key of the key pair associated with an application.

At operation 510, processing logic sends, to the computing device, the signed hash digest. In some embodiments, the processing logic can also send the public key and the security context.

At operation 512, processing logic receives a response from the computing device, indicative of whether the security context has been provisioned. If the response is indicative of the security context being provisioned, the processing logic can access the data assets referenced by the security context.

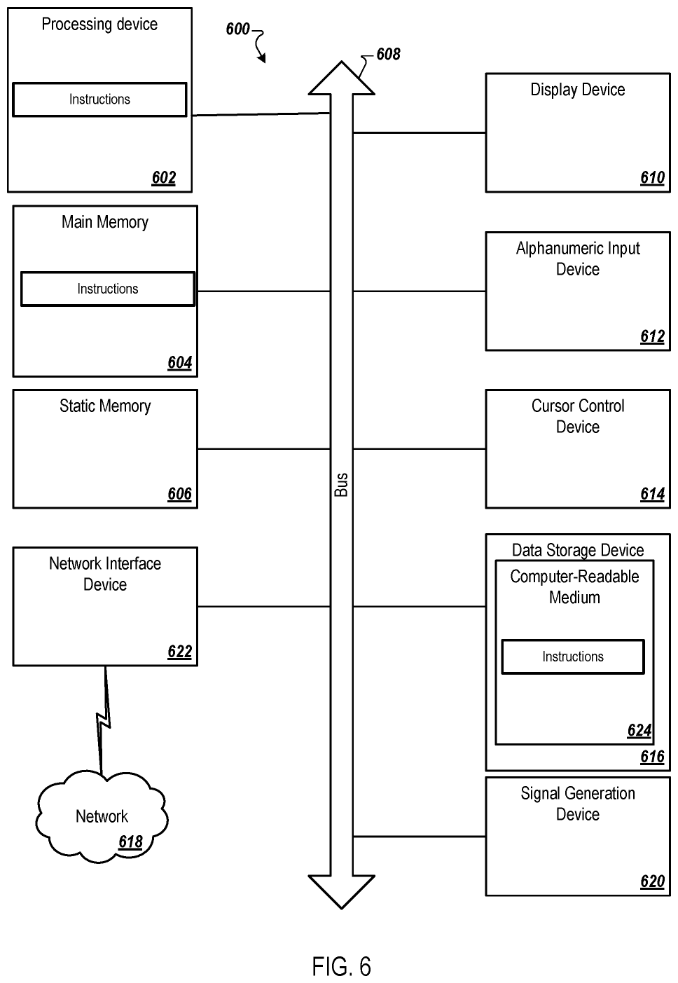

FIG. 6 is a block diagram illustrating an exemplary computer system 600, in accordance with some implementations of the disclosure. The computer system 600 executes one or more sets of instructions that cause the machine to perform any one or more of the methodologies discussed herein. Set of instructions, instructions, and the like can refer to instructions that, when executed by computer system 600, cause computer system 600 to perform one or more operations of computing device 106 and/or provisioning device 120. The machine can operate in the capacity of a server or a client device in a client-server network environment, or as a peer machine in a peer-to-peer (or distributed) network environment. The machine can be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a static memory 606 (e.g., flash memory, static random access memory (SRAM), etc.), and a data storage device 616, which communicate with each other via a bus 608.

The processing device 602 represents one or more general-purpose processing devices such as a microprocessor, central processing unit, or the like. More particularly, the processing device 602 can be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 is configured to execute instructions of the computer system 100 for performing the operations discussed herein.

The computer system 600 can further include a network interface device 622 that provides communication with other machines over a network 618, such as a local area network (LAN), an intranet, an extranet, or the Internet. The computer system 600 also can include a display device 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 can include a non-transitory computer-readable storage medium 624 on which is stored the sets of instructions of the computer system 100 embodying any one or more of the methodologies or functions described herein. The sets of instructions can also reside, completely or at least partially, within the main memory 604 and/or within the processing device 602 during execution thereof by the computer system 600, the main memory 604 and the processing device 602 also constituting computer-readable storage media. The sets of instructions can further be transmitted or received over the network 618 via the network interface device 622.

While the example of the computer-readable storage medium 624 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that cause the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure can be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It can be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus can be specially constructed for the required purposes, or it can include a general-purpose computer selectively activated or reconfigured by a computer program stored in the computer. Such a computer program can be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims can generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. The terms “first,” “second,” “third,” “fourth,” etc. as used herein are meant as labels to distinguish among different elements and can not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional implementations, one or more processing devices for performing the operations of the above described implementations are disclosed. Additionally, in implementations of the disclosure, a non-transitory computer-readable storage medium stores instructions for performing the operations of the described implementations. Also in other implementations, systems for performing the operations of the described implementations are also disclosed.

It is to be understood that the above description is intended to be illustrative, and not restrictive. Other implementations will be apparent to those of skill in the art upon reading and understanding the above description. The scope of the disclosure can, therefore, be determined with reference to the appended claims, along with the full scope of equivalents to which such claims are entitled.

What is claimed is:

1. A method comprising:
receiving, by a first device from a second device, a request to provision a security context for the second device;
transmitting a nonce value to the second device;
receiving, from the second device, a data structure encoding the security context and a cryptographically signed digest of a combination of the data structure, the nonce value, and a public key;
determining a first digest using the nonce value and cryptographically signed digest;
determining a second digest using the data structure, the nonce value, and the public key; and
responsive to determining that the first digest matches the second digest, provisioning the security context for the second device by storing the security context on the volatile memory.

2. The method of claim 1, further comprising:
controlling, using the security context, access of an application executing on the first device to a resource.

3. The method of claim 1, further comprising:
generating the nonce value and storing the nonce value in the volatile memory.

4. The method of claim 1, further comprising:
obtaining the nonce value from the volatile memory.

5. The method of claim 1, further comprising:
receiving, from the second device, the public key, wherein the first digest is determined by decrypting the cryptographically signed digest using the public key.

6. The method of claim 1, wherein the cryptographically signed digest is obtained using a private key corresponding to the public key.

7. The method of claim 6, wherein the private key and the public key are associated with an application executing on the second device.

8. The method of claim 1, wherein the data structure comprises an identifier associated with the application, one or more context identifiers and at least one access state for each of the one or more content identifiers.

9. A system, comprising:
a volatile memory device; and
a processing device, coupled to the memory device, to:
receive, from a first device, a request to provision a security context for the second device;
transmit a nonce value to the first device;
receive, from the first device, a data structure encoding the security context and a cryptographically signed digest of a combination of the data structure, the nonce value, and a public key;
determine a first digest using the nonce value and cryptographically signed digest;
determine a second digest using the data structure, the nonce value, and the public key; and
responsive to determining that the first digest matches the second digest, provision the security context for the first device by storing the security context on the volatile memory.

10. The system of claim 9, wherein the processing device is further to:
control, using the security context, access of an application executing on the first device to a resource.

11. The system of claim 9, wherein the processing device is further to:
generate the nonce value and storing the nonce value in the volatile memory.

12. The system of claim 9, wherein the processing device is further to:
obtain the nonce value from the volatile memory.

13. The system of claim 9, wherein the processing device is further to:
receive, from the second device, the public key, wherein the first digest is determined by decrypting the cryptographically signed digest using the public key.

14. The system of claim 9, wherein the processing device is further to:
wherein the cryptographically signed digest is obtained using a private key corresponding to the public key.

15. The system of claim 14, wherein the private key and the public key are associated with an application executing on second first device.

16. The system of claim 9, wherein the data structure comprises an identifier associated with the application, one or more context identifiers and at least one access state for each of the one or more content identifiers.

17. A non-transitory machine-readable storage medium storing executable instructions which, when executed by a processing device, cause the processing device to:
receive, from a first device, a request to provision a security context for the second device;
transmit a nonce value to the first device;
receive, from the first device, a data structure encoding the security context and a cryptographically signed digest of a combination of the data structure, the nonce value, and a public key;
determine a first digest using the nonce value and cryptographically signed digest;
determine a second digest using the data structure, the nonce value, and the public key; and
responsive to determining that the first digest matches the second digest, provision the security context for the first device by storing the security context on the volatile memory.

18. The non-transitory machine-readable storage medium of claim 17, further comprising instructions that cause the processing device to:
control, using the security context, access of an application executing on the first device to a resource.

19. The non-transitory machine-readable storage medium of claim 17, further comprising instructions that cause the processing device to:
generate the nonce value and storing the nonce value in the volatile memory.

20. The non-transitory machine-readable storage medium of claim 15, further comprising instructions that cause the processing device to:
obtain the nonce value from the volatile memory.
